(19) United States
(12) Patent Application Publication
(10) Pub. No.: US 2011/0296599 A1
(43) Pub. Date: Dec. 8, 2011

(54) QUICK FIXING

(76) Inventor: Joseph Emmanuel BROWN, Bedfordshire (GB)

(21) Appl. No.: 13/153,895

(22) Filed: Jun. 6, 2011

(30) Foreign Application Priority Data
Jun. 8, 2010 (GB) 1009560.2

(51) Int. Cl. A47K 13/00; B23P 17/04

(52) U.S. Cl. 4/237; 29/428

(57) ABSTRACT

A quick fitting toilet seat fixing includes a tight fitting expandable sleeve with a larger shaped top section to suite the toilet seat assembly, a tapered hole through the middle, that is pushed down into the holes at the back of the toilet bowl, and a tapered shaft with a threaded end that screw into the toilet seat assembly. The tapered shaft is then pushed inside the expandable sleeve so that the tapered sides of the expandable sleeve are placed under a lateral pressure resulting in a tight fixing. The bottom of the tapered shaft will protrude through the sleeve when it is fully fitted, this will allow the tapered shaft to be pushed vertically upward thus releasing the lateral pressure so the fixing can be removed.

### FIELD OF INVENTION

This invention relates to a device for securing a toilet seat to the porcelain bowl of a toilet.

### BACKGROUND TO THE INVENTION

New toilet seats are generally fitted using a long threaded bar and a fastener that is positioned beneath the back of the toilet. Fitting is difficult even when the area in which the toilet is located is accessible, but most toilets are fitted into a corner or in a small room.

Furthermore, many modern toilets seek to hide the seat fittings, requiring a fitter to reach around the back of the system and spend a very uncomfortable time winding the fastener in order to get it as tight as possible. Because of this most women will get a man to fit the toilet seat for them. Furthermore, the area of the fixings is frequently only removed and cleaned when the toilet seat breaks.

### STATEMENT OF THE INVENTION

To overcome this, the present invention proposes a fixing system that can be operated from a standing position above the toilet using a push in fixing.

In accordance with one aspect of the present invention there is provided a quick fitting toilet seat fixing comprising an expandable sleeve and a shaft insertable into the sleeve and configured to attach to a toilet seat assembly.

In accordance with another aspect of the present invention there is provided a method of fixing a toilet seat assembly to a toilet bowl. The method comprises pushing an expandable sleeve into a hole in the toilet bowl, and inserting a shaft fixed to the assembly into a hole of the expandable sleeve so as to apply a lateral force on the expandable sleeve to secure the fixing.

### BRIEF DESCRIPTION OF THE DRAWINGS

Some preferred embodiments will now be described by way of example only and with reference to the accompanying drawings, in which:

FIG. 1A is a cross-section through an expandable sleeve;

FIG. 1B is a plan view of the sleeve of FIG. 1A;

FIG. 1C is a cross-section through an alternative expandable sleeve;

FIG. 1D is a plan view of the sleeve of FIG. 1C;

FIG. 2A is a side view of a tapered shaft for insertion into the sleeve of FIG. 1A;

FIGS. 2B and 2C are side views of alternative tapered shafts for insertion into the sleeve of FIG. 1C;

FIG. 3A is a side view of an alternative shaft for insertion into the sleeve of FIG. 1A or FIG. 1C; and

FIG. 3B is a plan view of the shaft of FIG. 3A.

### DETAILED DESCRIPTION OF THE EMBODIMENTS

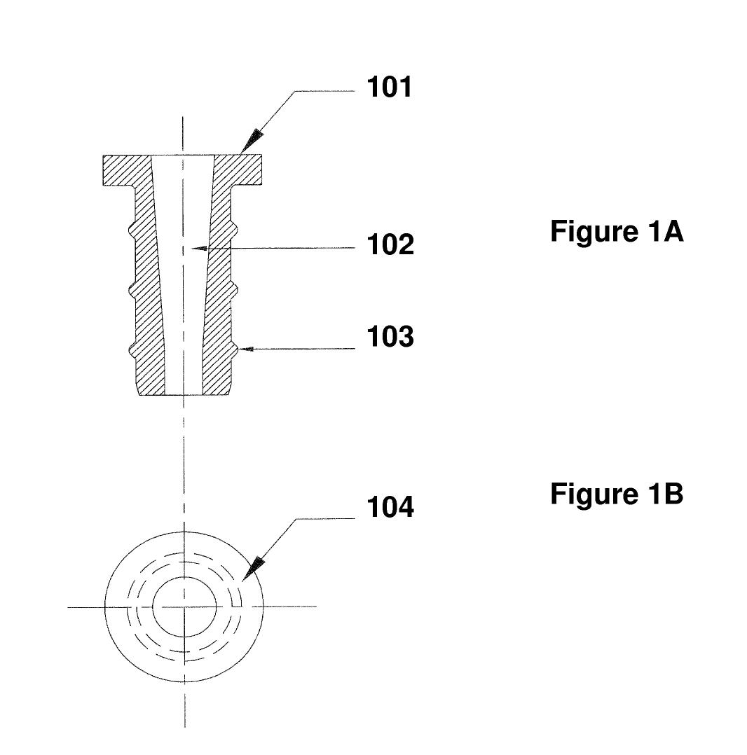

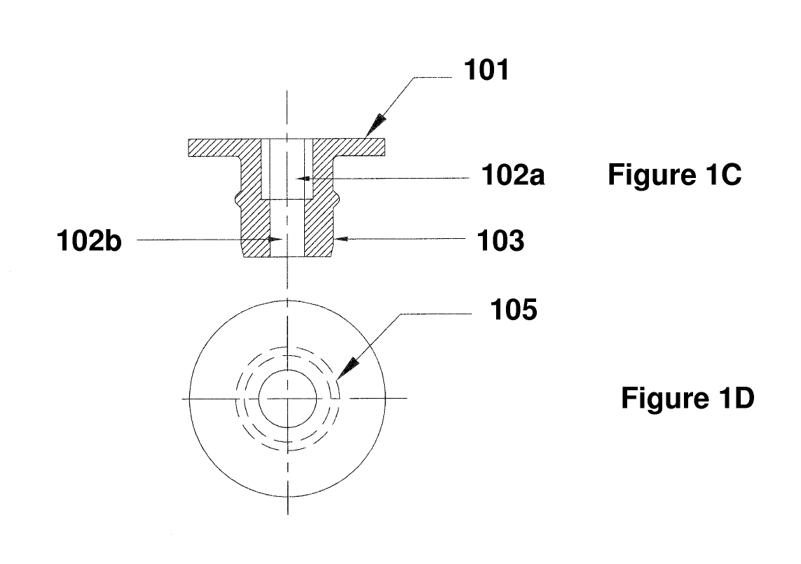

FIG. 1A is a cross-section through an expandable sleeve designed to be pushed in to the small hole at the rear of a porcelain toilet bowl so as to create an interference fit. Ribs 103 on the expandable sleeve assist in creating the interference fit with the porcelain toilet bowl. The top 101 of the sleeve includes a flange larger than the hole so as to hold the sleeve in place. This can also be shaped to fit the different fitting points of various toilet seats.

The sleeve has a vertical tapered hole 102 which extends through the sleeve. The hole 102 is wider at the top of the sleeve than at the bottom.

FIG. 1B is a plan view 104 of the tapered hole extending vertically through the sleeve.

FIG. 1C is an alternative cross-section through an expandable sleeve. This sleeve is also designed to be pushed in to the small hole at the rear of a porcelain toilet bowl so as to create an interference fit. Many features of the sleeve of FIG. 1C are similar to those of FIG. 1A. However, in this example, the sleeve is shorter and the hole includes two straight sections 102a, 102b of different widths rather than being continuously tapered.

FIG. 1D is a plan view 105 of the hole extending vertically through the sleeve of FIG. 1C.

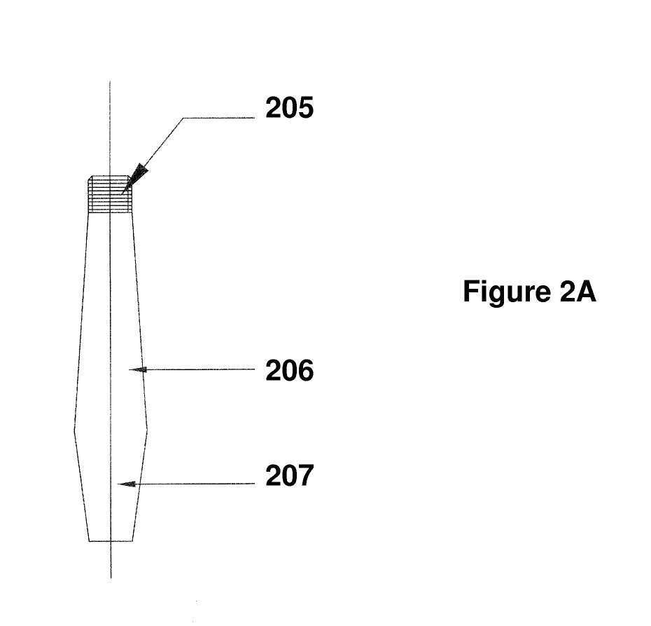

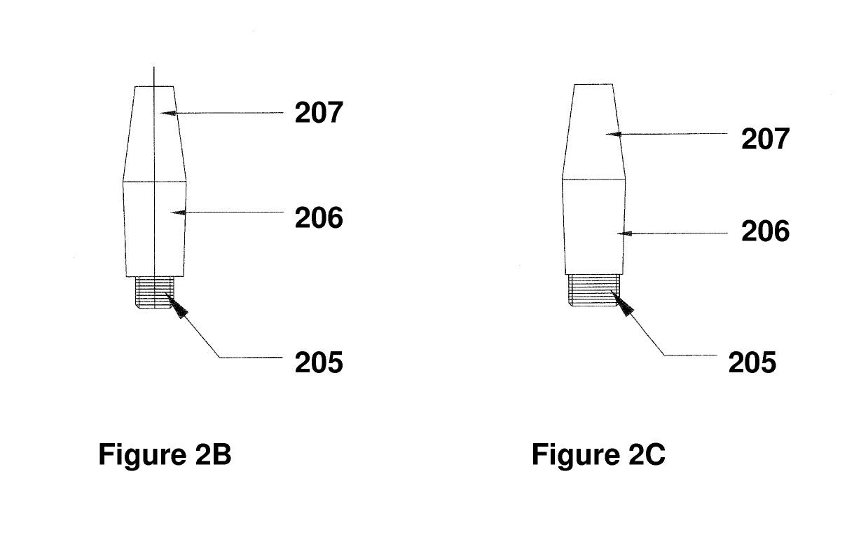

FIG. 2A is a side view of a tapered shaft 206, which is threaded at its upper end 205 so that it can be screwed into a toilet seat fixing point. The shaft is tapered in such a way that the device increases away from the threaded upper end. The shaft 206 can then be pushed into the tapered hole 102 in the expandable sleeve. This expands the sleeve and thereby forms a tight grip on the porcelain bowl, thus securing the toilet seat. The taper in the shaft 206 applies a lateral force on the expandable sleeve and thus secures the fixing. The lower end 207 of the shaft 206 has a reverse taper designed to protrude below the sleeve. The protruding section can be pushed vertically upwards to allow the fixing to be removed.

FIGS. 2B and 2C are side views of alternative tapered shafts. Many features of these shafts are similar to that of FIG. 2A and therefore carry the same reference numerals. However, the shafts of FIGS. 2B and 2C have different shapes. For example, the reverse tapered section 207 of these shafts is relatively longer compared to the tapered section. The taper of the upper half of the shafts 206 also has a different shape compared to that of FIG. 2A.

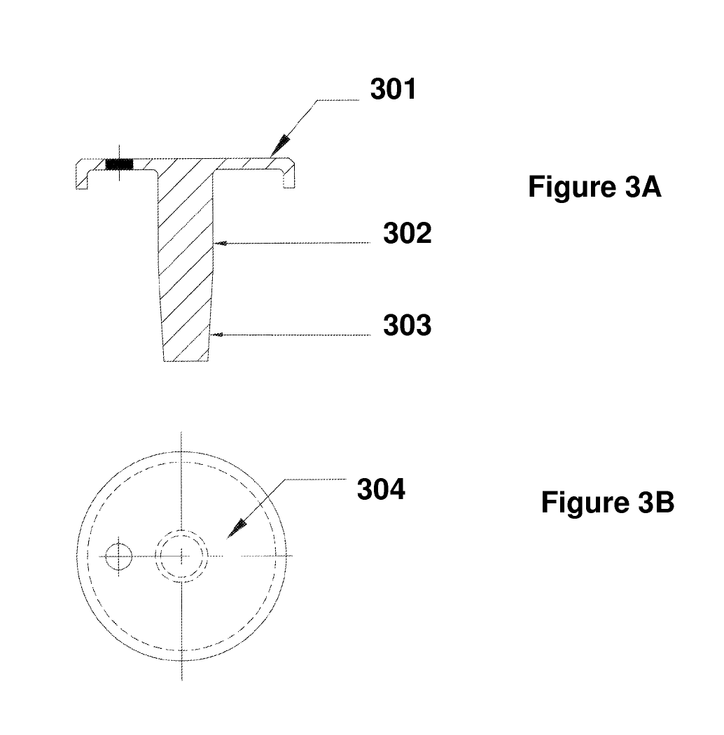

FIG. 3A is a side view of an alternative shaft for insertion into the sleeve of FIG. 1A or FIG. 1C. The shaft 302 is not threaded at its upper end 301 but includes a head section which is moulded to the shaft 302 to attach to any compatible toilet seats. In this example, the shaft 302 is not tapered in its upper section, but it will be appreciated that tapering of the type shown in FIGS. 1a, 2b and 2c may also be applied to this embodiment. The removal of the threaded section at the top of the shaft allows for the shaft to be integrated into many different toilet seats. It will be noted that the quick fixing in this instance is used to secure a toilet seat to a toilet bowl. However, it will be appreciated that it can be used to secure any item to a suitable point. The tapered shaft can be moulded on to any number of different shapes for a variety of different applications.

FIG. 3B is a plan view of the shaft of FIG. 3A, extending vertically.

The arrangement described above has a number of advantages. The seat can be fitted from a standing position above the toilet. The fixing system can be operated directly from above the toilet if the underneath of the toilet fixing points can not be accessed. Mounting the seat on the expandable sleeve allows the possibility of lateral movement if knocked or hit by accident. Instead of straining the joints or the fixing assembly itself the seat simply moves slightly to one side and then moves back to the original position. The expandable mounting gives the user the ability to remove the complete fixing assembly as often as required. Once the seat has been fitted it can be removed and replaced in seconds. Furthermore, the fixing system does not leave any space for dirt and germs to collect. The fixing system is quick and can be removed easily for cleaning. The fixing system is easy and can be fitted by anyone without help. The fixing system uses fewer parts than threaded systems. The fixing system does not require the fitter to kneel and turn a nut which is difficult to reach. As there are no threads underneath the basin, the seat assembly will not become rusted and hard to remove.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1. A quick fitting toilet seat fixing comprising:
an expandable sleeve; and
a shaft configured to attach to a toilet seat assembly and insertable into the expandable sleeve.

2. The seat fixing of claim 1, wherein the shaft is tapered so that it increases in width from a top end configured to attach to the toilet seat assembly.

3. The seat fixing of claim 1, wherein the shaft comprises a head section which is configured to be moulded with the shaft to attach to the toilet seat assembly.

4. The seat fixing of claim 1, wherein the expandable sleeve is machined or moulded to provide an interference fit into a hole at the rear of a toilet bowl assembly.

5. The seat fixing of claim 4, wherein the expandable sleeve comprises a tapered hole extending therethrough for receiving the tapered shaft attached to the toilet seat assembly.

6. The seat fixing of claim 4, wherein the expandable sleeve comprises a hole extending therethrough and having at least two discrete sections with different diameters for receiving the tapered shaft attached to the toilet seat assembly.

7. The seat fixing of claim 5, configured so that the tapered sides of the expandable sleeve are placed under a lateral pressure resulting in a tight fixing when the tapered shaft is inserted into the sleeve.

8. The seat fixing of claim 1, wherein the expandable sleeve comprises a head section which is larger than the rest of the sleeve and shaped to fit into the toilet seat assembly.

9. The seat fixing of claim 1, wherein the tapered shaft comprises a threaded section for screwing into the toilet seat assembly.

10. The seat fixing of claim 1, wherein the tapered shaft is long enough to protrude through the expandable sleeve so it can be pushed back up into the sleeve to remove the fixing.

11. A method of fixing a toilet seat assembly to a toilet bowl, comprising:
pushing an expandable sleeve into a hole in the toilet bowl; and
inserting a shaft fixed to the assembly into a hole of the expandable sleeve so as to apply a lateral force on the expandable sleeve to secure the fixing.

12. A method of claim 11, further comprising screwing the shaft into a toilet seat fixing point of the toilet seat assembly.

13. A method of claim 11, wherein the shaft is an integral part of the toilet seat assembly.
